(19) United States
(12) Patent Application Publication
(10) Pub. No.: US 2026/0159238 A1
(43) Pub. Date: Jun. 11, 2026

(54) SYSTEM AND METHOD FOR SKY ART USING UNMANNED AERIAL VEHICLES

(71) Applicant: Jesse Deniro Collings, Stonecrest, GA (US)

(72) Inventor: Jesse Deniro Collings, Stonecrest, GA (US)

(21) Appl. No.: 19/378,699

(22) Filed: Nov. 4, 2025

Related U.S. Application Data
(60) Provisional application No. 63/729,434, filed on Dec. 8, 2024.

(51) Int. Cl. B64D 1/20; B64U 10/14; B64U 101/45

(52) U.S. Cl. CPC B64D 1/20; B64U 10/14; B64U 2101/45; B64U 2201/104

(57) ABSTRACT

The invention is a sky-art system that makes use of UAV maneuverability and compensation for atmospheric conditions and forces coupled with an attached subsystem that provides control over smoke generation, smoke flow, and positioning.

This application claims the benefit of U.S. Provisional Application No. 63/729,434, filed Dec. 8, 2025, under 35 U.S.C. 119(e).

### TECHNICAL FIELD

The invention is a system and method for equipping and using unmanned aerial vehicles (UAVs) to create in-sky reflective clouds and drawing or projecting images thereon.

### BACKGROUND OF INVENTION

The first form of sky art was called “sky writing” wherein airplanes equipped with smoke-generating means would maneuver while starting and stopping the flow of smoke so as to create letters and simple shapes against a blue sky. The letters and shapes were visible to people on the ground.

The complexity of letters and shapes was limited by the maneuverable flexibility of the manned aircraft. And, the duration of the art thus formed was limited by atmospheric factors such as heat, humidity and wind.

UAVs, compared to even the smallest of manned aerial vehicles are inherently smaller, more agile, and capable of very precise control. The propellers on UAVs, under UAV control subsystem, can compensate for external forces affecting vertical, horizontal and yaw motion. Within limits, a UAV can achieve motionless hovering using its control subsystem to apply compensating forces nullifying the external forces being applied to it.

Currently, UAVs are used for a variety of purposes including aerial photography. With the appropriate equipment, UAVs could also become a means of producing sky art.

### BRIEF DESCRIPTION OF THE INVENTION

The invention herein disclosed is a sky-art system and method of use that can enable a person on the ground to create artistic designs in the sky. It is operative to attach firmly to a UAV, make use of the UAV's control subsystem, and provide its own subsystems supporting the creation of sky art.

The invention comprises an aerodynamic enclosure attached to the UAV. Within the aerodynamic structure are a smoke generation subsystem, smoke-control subsystem, and a smoke-delivery subsystem that can be deployed to be positioned and deliver smoke flow under the direction of the smoke-control subsystem.

The smoke-control subsystem converts user command inputs into UAV motion, pipe positioning, and smoke flow needed to carry out those commands.

In its most basic application, the sky-art system can provide sky-writing like the manned aerial vehicles of old but with much greater control over maneuverability and smoke density. Rather than being limited to simple fonts, the UAV sky-art system can produce a great variety of serif and sanserif fonts.

Unlike the current sky-writing capabilities, the UAV sky-art system can create reflective surfaces upon which images may be drawn or projected. The projection can be done using subsystems on the UAV, or, laser-lighting subsystems on the ground. With an appropriate user interface, a user can create a “sky canvas” and fill it with combinations of objects, letters, and colors.

Collaboration between the UAV control subsystem and the smoke-control subsystem offers significant compensation for external atmospheric conditions and forces. One or more programs running in the smoke-control subsystem, collaborating with the UAV's control subsystem, enables the user to control the art production while the smoke-control and UAV-control subsystems work to attain and preserve the necessary maneuverability and smoke flows that support that art production.

In essence, the invention produces dense, controllable, and persistent plumes; supports fully onboard heating or, in alternative embodiments, rapid ground pre-heating with in-flight thermal maintenance. It integrates with flight software for autonomous symbol writing; it can log usage/telemetry; and can provide luminous plume capability for night viewing.

The preferred embodiment uses programmable logic controller (PLC) heaters on board whereas an alternative embodiment may provide pre-heated effluent with no onboard PLC heating.

### BRIEF DESCRIPTION OF DRAWINGS

FIG. 1 depicts an embodiment of the invention with all subsystems in place.

FIG. 2a depicts an embodiment of the invention creating a reflective cloud “canvas”.

FIG. 2b shows the same view as FIG. 2a where the cloud canvas has an artwork produced on it using smoke.

FIG. 2c shows the same view as FIG. 2a where the cloud canvas has a message produced on it using smoke.

FIG. 3a shows an embodiment where after a cloud canvas has been produced a projection subsystem on the UAV projects an image on the cloud canvas.

FIG. 3b shows an embodiment where after a cloud canvas has been produced, a projection subsystem on the ground projects an image on the cloud canvas.

FIG. 4 shows an embodiment where multiple UAVs work in concert and concurrently create a very large cloud canvas.

FIG. 5 shows a flow diagram of an embodiment where a sequence of steps and their supporting subsystems carry out a sky-art project at a specific location in the sky.

FIG. 6 shows an embodiment of the subsystems and their interrelationships.

FIG. 7 shows a flow diagram of an embodiment in which the fluid is pre-heated on the ground so there is no heating step during flight.

FIG. 8 shows the smoke generation subsystem for an embodiment in which heating is done in flight.

FIG. 9 shows the smoke generation subsystem for an embodiment in which heating is done on the ground before flight.

FIG. 10 illustrates an embodiment of the smoke control subsystem.

### DETAILED DESCRIPTION OF INVENTION

The invention makes use of a UAV outfitted with additional subsystems dedicated to sky-art production. By sky art, one means creating smoke patterns in the sky using precise smoke flow and UAV manipulation. It can also mean projecting images on reflective smoke patterns. These reflective smoke patterns are also called “plumes.”

UAVs, unmanned drones for example, are capable of detecting and counteracting external atmospheric conditions and forces so as to hover essentially motionless in one position, or move and maneuver very precisely despite those external atmospheric conditions and forces.

UAV control systems, making use of sensors, can detect changes that would affect position or motion and apply compensating UAV action by changing propeller speed and or orientation.

When a UAV is equipped with a sky-art system, the UAVs inherit stabilizing

controls coupled with the sky-art systems smoke generation and smoke flow subsystems can provide precise and high-resolution smoke flow positioning and density to produce detailed, proportioned, art work and to maximize persistence of that art work once an art project is completed.

The sky-art system comprises an aerodynamic enclosure called a “payload,” coupled to the UAV within which smoke-control and smoke-generation subsystems and smoke-delivery subsystem are all contained.

The smoke-delivery subsystem comprises a pipe that conveys smoke flow from the smoke-generation subsystem to a selected area of sky. During flight to the art-project sky position the smoke-delivery pipe is folded into the aerodynamic enclosure much like an airplane's landing gear are folded into a recessed area of wing, for example. This reduces drag and allows the UAV to proceed to the sky position efficiently.

Once in position, the smoke-control subsystem instructs the smoke-delivery subsystem to rotate the pipe such that it exits the surface of the aerodynamic enclosure and may be positioned up to 180 degrees away. In addition, the pipe has a telescoping inner pipe which can be extended further away from the UAV. This function has multiple purposes. It can position smoke delivery away from propeller “wash,” and can also in conjunction with UAV motion increase the efficiency of smoke delivery to selected positions in the sky.

As smoke is being generated within the smoke-generation subsystem, a pump subsystem within the smoke-generation subsystem controls smoke flow to the smoke-delivery subsystem.

The smoke-control subsystem is operative to receive user art-related inputs and, in conjunction with the UAV control system, control smoke position and delivery in sync with UAV position and motion. By so doing, very intricate shapes can be produced of the reflective cloud canvas as well as objects placed on the cloud canvas. It can also allow both serif and sanserif fonts to be used for alphanumeric messaging. The system uses non-transitory computer-readable medium for storing instructions that, when executed by a processor of a mobile device or companion computer, cause the device to: accept user text or emoji; compute a flight path and emission schedule tempered by environmental conditions; and to transmit start/stop and modulation commands among user-control applications and smoke-control subsystem.

Control of the UAV position and motion, and the sky-art subsystem's smoke generation and delivery are part of a closed loop control algorithm. As a user inputs sky-art directives, the UAV and sky-art subsystem operate collaboratively to make the art directives as precise as possible by adjusting for forces that would affect vertical motion, horizontal motion and yaw motion (e.g. rotation around a center of mass). The net result is an optimized art production very marginally affected by external atmospheric conditions and forces.

The following drawings and descriptions are meant to be exemplary and should not be read as limiting the scope of the invention.

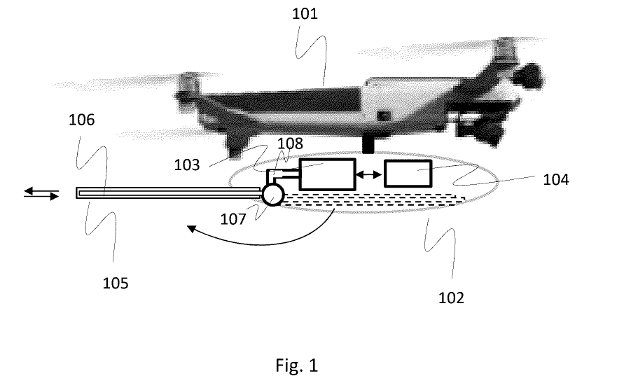

In FIG. 1, the UAV (101) has the sky-art subsystem coupled to it. Inside the aerodynamic enclosure (102) are the smoke-control subsystem (104), the smoke-generation subsystem (103), the smoke-delivery subsystem (107) and the sky-art pipe structure (105 and 106). Initially the pipe (dashed lines) is folded into the aerodynamic enclosure structure. Ultimately, before art production begins, the pipe is rotated as shown by the arrow up to 180 degrees. Once it is at the desired position, it is locked in place by the smoke-control subsystem and smoke-delivery subsystem. As shown by the arrows near the free end of the sky-art pipe, an inner pipe structure (106) is operative to extend and retract under control of the smoke-control and smoke-delivery subsystems. The flow of smoke produced by the smoke generator is conveyed to the smoke-delivery subsystem by a fixture (108). A valve and pressure subsystem (not shown) would control delivery and density of smoke exiting the smoke-delivery pipe.

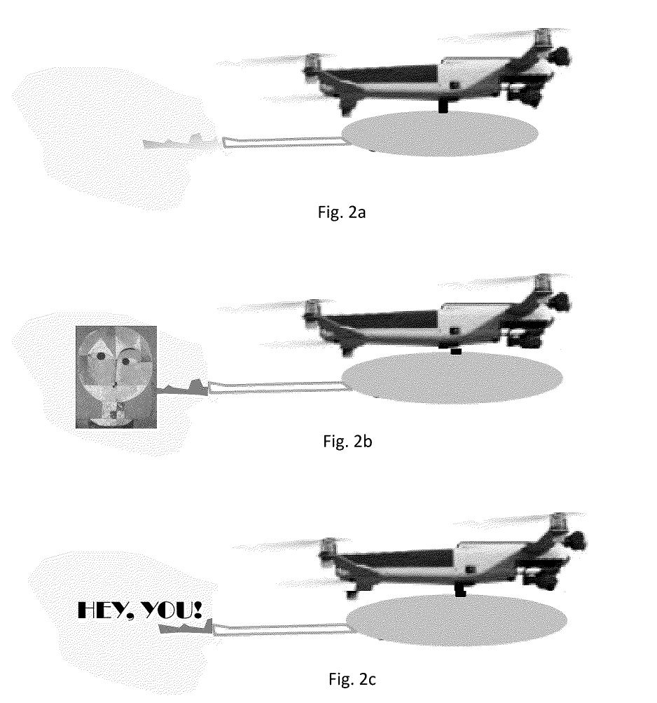

FIG. 2a shows an exemplary view of a sky-art equipped UAV creating a cloud canvas plume.

FIG. 2b shows an exemplary view of the sky-art pipe producing an art image on the cloud canvas plume.

FIG. 2c shows an exemplary view of the sky-art pipe producing a word message using a very distinctive font. In 2a, b and c, the art images are “drawn” on the cloud canvas using smoke resulting from emissions of heated aerosol liquids.

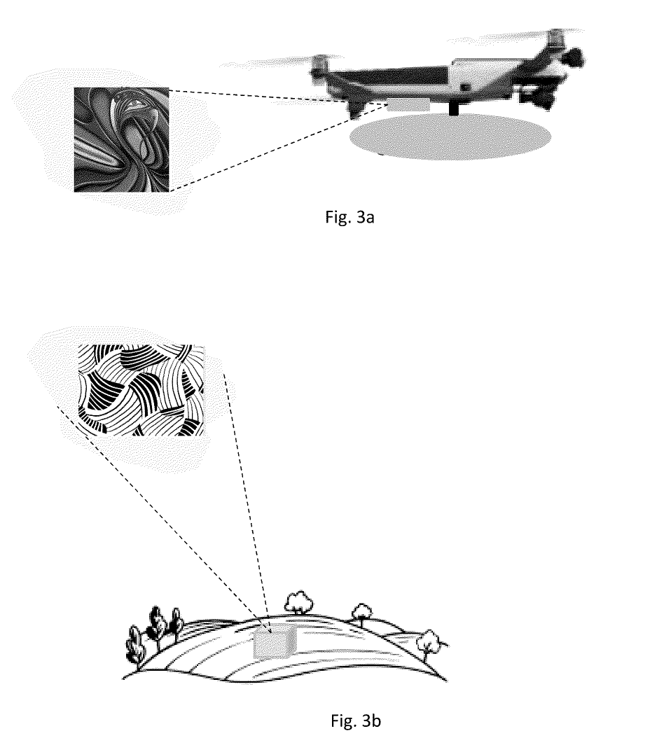

In FIG. 3a, an exemplary view of sky-art equipped UAV is shown using a projection subsystem (301) to project an image on the cloud canvas plume.

In FIG. 3b, an exemplary view shows a ground-based projection subsystem (302) projecting an image on the cloud canvas plume.

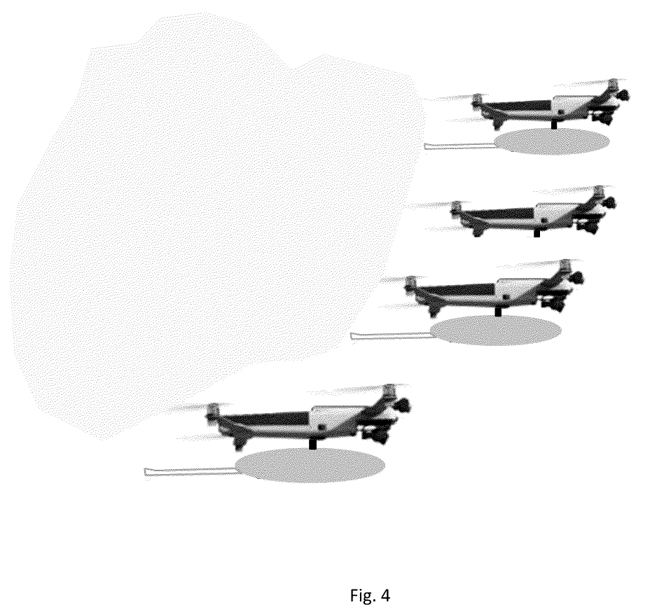

In FIG. 4, a group of four, synchronized sky-art system equipped UAVs work in concert to produce a large cloud canvas plume much more quickly than would be possible with just one UAV. Smoke-produced art work could also be done in parallel by the multiple UAVs also taking far less time and raising efficiency. A single user application could control the emissions of multiple UAVs, transparently.

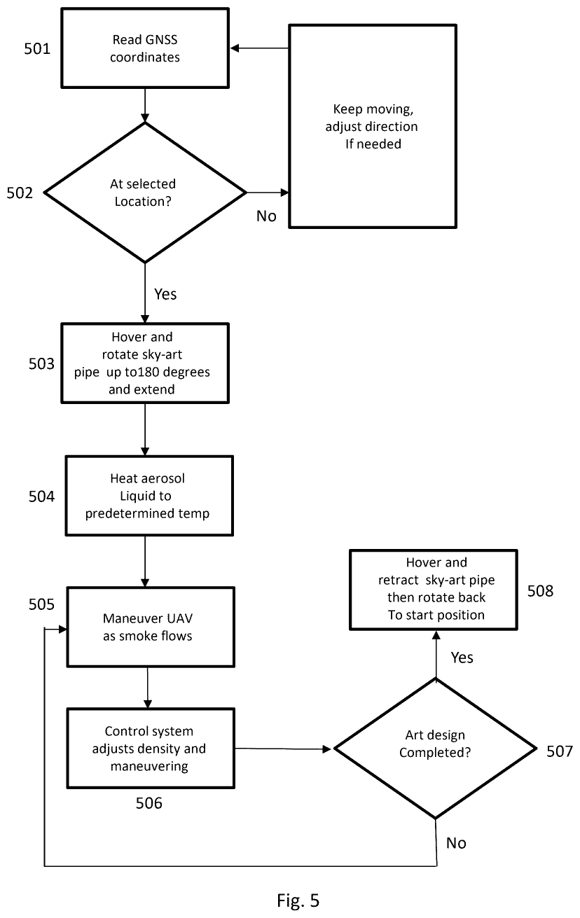

FIG. 5 is a step flow diagram showing an exemplary sequence of steps underpinning an sky-art art project. The sky-art project would specify a sky position, thus, as the sky-art-subsystem equipped UAV flies toward that position, it would read its real-time, global navigation satellite system (GNSS) coordinates (501) and conditionally determine if it was at the selected position (502). If not, it would continue to move (503) until the GPS coordinates match those of the selected position. Then, the sky-art equipped UAV would hover and heat the aerosol fluid (504) and rotate the smoke-delivery pipe up to 180 degrees from its folded position. If so directed by the smoke-control subsystem, it would extend the telescoping inner smoke-delivery pipe. Based on smoke-control subsystem directives, the smoke-generation subsystem would initiate smoke generation (505) and coordinate UAV motion and smoke flow (506). The combination of UAV control-subsystem and smoke-control subsystem cooperation would allow precise adjustments to smoke density concurrent with UAV maneuvering (507). A conditional check on art design completeness (508) is done, and if not yet complete, steps 506 and 507 would continue until the project is deemed completed. Then, 509, the UAV would hover in position, retract and rotate the sky-art pipe so that it is nested with the aerodynamic enclosure.

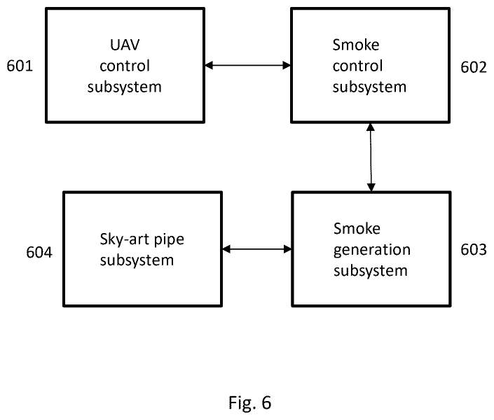

FIG. 6 is an exemplary system view of the sky-art subsystem and its related subsystems. The UAV (drone) control subsystem (601) and smoke-control subsystem (602) collaborate together to coordinate smoke flow with UAV position and motion. This provides very precise art production despite varying atmospheric conditions and forces. The smoke-control subsystem directs the smoke-generation subsystem (603) and smoke-delivery subsystem (604) work together to vary smoke density and flow with atmospheric conditions and forces based on the collaboration between the smoke-control subsystem and the UAV-control subsystem.

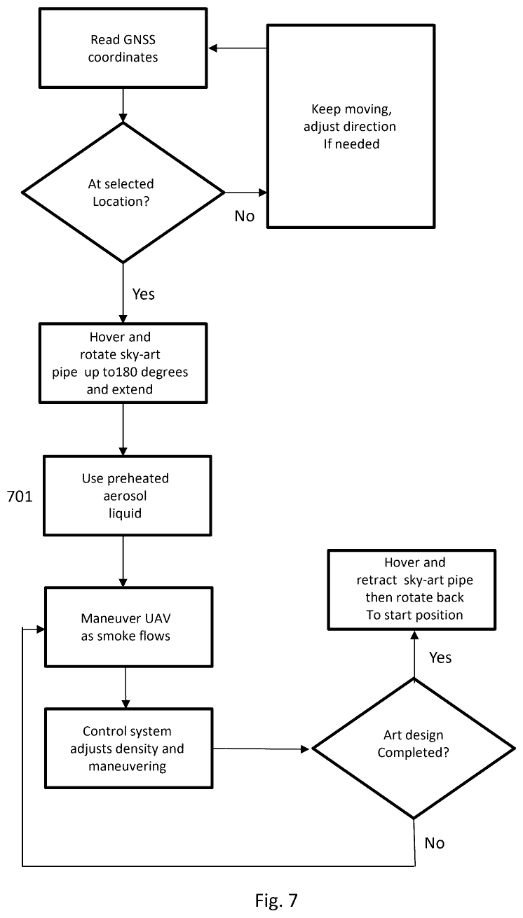

FIG. 7 shows a flow for an embodiment wherein the aerosol liquid is heated prior to launching of the UAV. As such the heating step (504, FIG. 5) is replaced by step 701 wherein the pre-heated liquid is used for smoke generation.

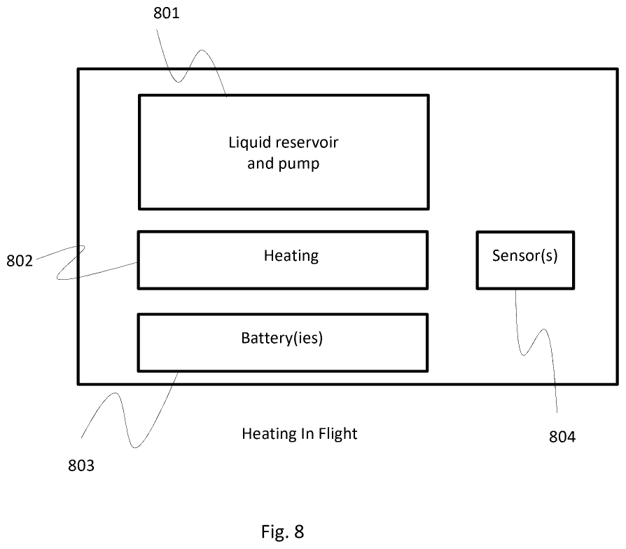

FIG. 8 shows an exemplary embodiment of a sky-art system's smoke-generation subsystem wherein the fluid in the reservoir (801) is heated, in flight, by the PLC heating (802) while powered by the onboard battery(ies), 803. Sensors (804) are used for sensing one or more of temperature, pressure and fluid level.

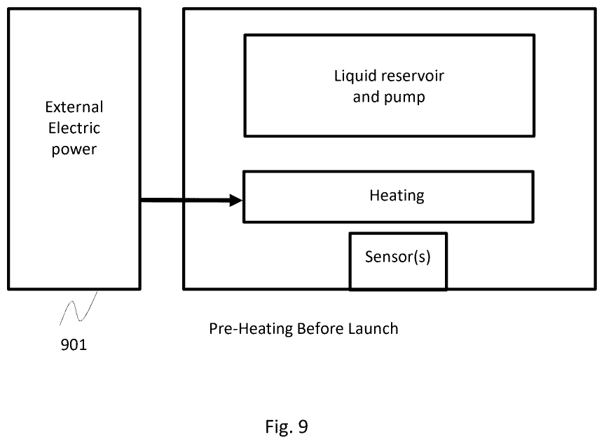

In FIG. 9, an embodiment that relies upon pre-heating prior to launch, the battery(ies) of FIG. 8 (803) are not used and, instead, heating power is provided by an external electrical power source. Appropriate wiring and connectors would be used (not shown) to support the power delivery.

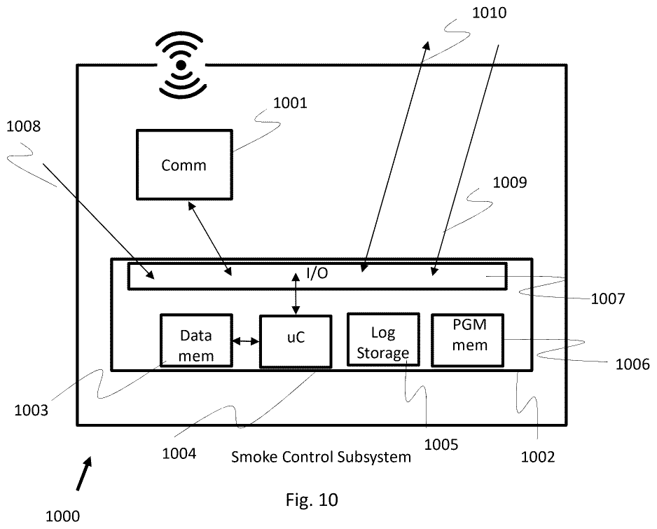

In FIG. 10, the smoke-control subsystem (602, FIG. 6) is shown in greater detail. The subsystem (1000) comprises a communication subsystem (1001), a controller-subsubsystem (1002) which is itself comprising a micro-controller (1004), data memory (1003), program memory (1006), logging storage (1005) and input-output, or I/O (1007). The communications subsystem provides wireless communications interface between the UAV's mounted payload, and more specifically its smoke-control subsystem. Data (1008) from the UAV's control system is conveyed to the I/O providing GNSS real-time inputs. Data from the sensors and reservoir/pump are inputted to the I/O, and control signals and confirmations are conveyed between I/O and heating and pumping functions in the smoke-generation subsystem.

The payload encasement should be efficiently aerodynamic in shape.

The aerosol liquid can be one or more of the group of glycol, glycerin, mineral oil, silicone oil and colorants.

The emission control program is operative to vary plume density based on wind conditions, and to illuminate a plume and/or art work based on ambient light conditions. Where multiple UAVs are employed, the emission control programs of each are synchronized via a user application making the single application capable of transparently controlling the multiple UAVs.

During flight and prior to emission, the heated aerosol fluid in the reservoir while being pumped through the sky-art pipe has a safe range of predetermined pressure, and the fluid in the reservoir has a safe range of temperature. Furthermore, a minimum level of aerosol fluid is predetermined below which it should not fall. These parameters are all readable using appropriate sensors. The control program is operative to lockdown operation when maximum limits are exceeded, or levels drop below predetermined minimums.

The drawings and descriptions are all exemplary and should not be read as limiting the claim scope.

What is claimed is:

1. A sky art system comprising:
a payload subsystem operative to attach to a UAV comprising:
a thermally insulated vaporization chamber subsystem;
at least one heating element subsystem;
a fluid reservoir and pump subsystem for containing and dispensing aerosol fluid;
a communications interface operative to receive emission commands;
a plurality of sensors capable of sensing temperature, flow, pressure and fluid levels; and
a controller subsystem operative to control smoke generation and delivery, and to cooperate with a UAV control system to synchronize position with emission at all times.

2. The system as in claim 1 wherein the controller executes closed-loop temperature control using the at least one temperature sensor and the at least one heating element subsystem.

3. The system as in claim 1 wherein the controller is operative to vary pump rate and chamber temperature.

4. The system as in claim 1 wherein the controller subsystem comprises:
a microcontroller;
at least one operational program;
data memory;
program memory; and
non-volatile storage for logging usage, emissions, and telemetry.

5. The system as in claim 1 wherein the communication interface subsystem is integrated with the UAV's flight control system to provide synchronized control of position and emission.

6. The system as in claim 1 further comprising:
a quick-attach mount and jettison subsystem.

7. The system as in claim 1 further comprising:
a plurality of optical emitters operative to illuminate aerosol to produce a luminous plume.

8. The system as in claim 1 wherein aerosol fluid comprises one or more of a group comprising glycol, glycerin, mineral oil, silicone oil and colorants.

9. The system as in claim 1 wherein the controller subsystem provides safety interlocks for instances where temperature, pressure, fluid and geographic upper limits are exceeded.

10. The system as in claim 1 wherein the controller subsystem provides safety interlocks for instances where reservoir fluid levels fall below predetermined lower limits.

11. A method for creating sky art using a sky-art system comprising:
launching a UAV with a sky-art subsystem payload;
receiving by the UAV instructions for position and emission control;
confirming, by a UAV control system, a position based on onboard GNSS reading;
executing, by a smoke-control subsystem, emission commands;
a) moving and confirming a next position;
b) executing next emission commands;
repeating steps a) and b) until all positions and emission commands have been executed; and
logging of positions, emission events and telemetry for each position.

12. The method of claim 11 wherein the executing emission commands comprises:
adapting mission timing to wind conditions and the UAV altitude.

13. The method of claim 11 wherein the executing emission commands comprises adapting plume density, based on wind conditions, to effect a stationary cloud.

14. The method of claim 11 wherein the execution emission commands comprises illumination of emission aerosols with synchronized light output.
